(19) United States
(12) Patent Application Publication
(10) Pub. No.: US 2013/0286164 A1
(43) Pub. Date: Oct. 31, 2013

(54) GLASSLESS 3D IMAGE DISPLAY APPARATUS AND METHOD THEREOF

(71) Applicant: SAMSUNG ELECTRO-MECHANICS CO., LTD., Gyeonggi-do (KR)

(72) Inventors: Joo Hyun KIM, Gyeonggi-do (KR); Aninash N. GOWDA, Gyeonggi-do (KR)

(73) Assignee: SAMSUNG ELECTRO-MECHANICS CO., LTD., Gyeonggi-so (KR)

(21) Appl. No.: 13/801,921

(22) Filed: Mar. 13, 2013

(30) Foreign Application Priority Data
Apr. 27, 2012 (KR) 10-2012-0044771

(51) Int. Cl. G06T 7/00; H04N 13/02

(52) U.S. Cl. CPC G06T 7/004; H04N 13/0242
USPC 348/48; 382/154

(57) ABSTRACT

Disclosed herein are an apparatus and a method for registering a user's face using two stereo cameras and displaying a glassless 3D image to a user using a single camera, in a handheld terminal. A glassless 3D image display apparatus according to an exemplary embodiment of the present invention includes: a first imaging unit extracting a single distance from a user; a second imaging unit connected with the first imaging unit to extract a stereo distance from the user; a control unit coinciding the single distance with the stereo distance; a distance information storage unit storing information on the single distance and the stereo distance coinciding with each other to register the user; a third imaging unit extracting the single distance from the user based on the stored distance information; and a display unit outputting the 3D image according to a distance extracted from the third imaging unit.

### CROSS REFERENCE(S) TO RELATED APPLICATIONS

This application claims the benefit under 35 U.S.C. Section 119, of Korean Patent Application Serial No. 10-2012-0044771, entitled “Glassless 3D Image Display Apparatus And Method Thereof” filed on Apr. 27, 2012, which is hereby incorporated by reference in its entirety into this application.

### BACKGROUND OF THE INVENTION

1. Technical Field

The present invention relates to a glassless 3D image display apparatus and a method thereof, and more particularly, to an apparatus and a method for registering a user's face using two stereo cameras and displaying a glassless 3D image to a user using a single camera, in a handheld terminal.

2. Description of the Related Art

A stereoscopic image representing a 3D image is formed by a stereoscopic visual principle through both eyes. An important factor of a cubic effect may be referred to as binocular disparity, that is, parallax that is shown due to an interval between both eyes. Therefore, a left eye and a right eye each input different two-dimensional images, which are in turn composed by a brain, thereby reproducing depth perception and reality of the 3D image.

A parallax barrier system according to the related art may output a display of a special glassless 3D image. The display apparatus using the parallax barrier system largely includes an apparatus alternatively displaying a left-eye image and a right-eye image for each of vertical stripes and a parallax barrier selectively covering light emitted from the display apparatus. As described above, the display apparatus permits only a user's left eye to view the left-eye image and only a user's right eye to view the right-eye image through slits formed between respective barriers of the parallax barrier, thereby allowing a user to view the 3D image.

Examples of a glassless 3D image display method may include a lenticular type and a parallax barrier type. Here, the parallax barrier method can be more simply implemented and more easily implement 2D-3D transform, as compared with the lenticular method. However, since the parallax barrier type has a narrow viewing angle and needs to optimally set a use position, a moving parallax barrier type has been mainly adopted. However, the moving parallax barrier type uses a position of a user's eye, that is, a distance between a point of view and a display and therefore, needs to measure the accurate point of view and the distance.

Therefore, in order to measure the accurate point of view and the distance, an infrared sensor, an ultrasonic sensor, and the like, need to be added separately or a stereo camera separate from the existing single camera is added on a front portion of the handheld terminal, which results in increasing cost of products.

### RELATED ART DOCUMENT

### Patent Document

(Patent Document 1) Korean Patent Laid-Open Publication No. 10-2011-0023842

### SUMMARY OF THE INVENTION

An object of the present invention is to provide optimal 3D image display environment by accurately measuring a position of a user's eye and a distance between a user's eye and a display.

Another object of the present invention is to prevent manufacturing cost of products from increasing by accurately measuring a point of view and a distance by a single camera of a front portion of the existing handheld terminal and a stereo camera of a back portion thereof, without adding a separate sensor or stereo camera.

According to an exemplary embodiment of the present invention, there is provided a glassless 3D image display apparatus, including: a first imaging unit extracting a single distance from a user; a second imaging unit connected with the first imaging unit to extract a stereo distance from the user; a control unit coinciding the single distance with the stereo distance; a distance information storage unit storing information on the single distance and the stereo distance coinciding with each other to register the user; a third imaging unit extracting the single distance from the user based on the stored distance information; and a display unit outputting a 3D image according to a distance extracted from the third imaging unit.

The first imaging unit may include a first stereo camera disposed on a back surface of the handheld terminal and a first distance calculator connected with the first stereo camera and calculating and extracting the single distance between the user and the first stereo camera, the second imaging unit may include a second stereo camera disposed at the left or the right on the same plane as the first stereo camera and a second distance calculator connected with the first stereo camera and the second stereo camera and calculating and extracting the stereo distance by the user and the first stereo camera and the second stereo camera, and the third imaging unit may include a single camera disposed at the front surface of the handheld terminal and a third distance calculator connected with the single camera and calculating and extracting the single distance between the user and the single camera according to the information stored in the distance information storage unit.

When the single distance extracted from the first distance calculator does not coincide with the stereo distance extracted from the second distance calculator, the control unit may control a weight by neural network learning for the first distance calculator to perform a feedback until the single distance extracted from the first distance calculator coincides with the stereo distance extracted from the second distance calculator.

The first distance calculator may calculate and extract a single distance between the user and the first stereo camera according to a distance between the user's left eye and right eye, a distance between the user's right eye and nose, and a distance between the user's nose and left eye, respectively.

The third distance calculator may calculate and extract a single distance between the user and the first stereo camera according to a distance between user's left eye and right eye, a distance between user's right eye and nose, and a distance between user's nose and left eye, respectively.

The distance information storage unit may store a distance between user's left eye and right eye, a distance between user's right eye and nose, and a distance between nose and left eye, respectively, which are calculated by the first distance calculator.

The distance information storage unit may store the distance between the user's left eye and right eye, the distance between the user's right eye and nose, the distance between the user's nose and left eye according to the single distance and the stereo distance coinciding with each other, and the single distance in response thereto, respectively.

The stereo distance may depend on the following Equation.

$$Z = \vert \frac{f \cdot B}{x 2 - x 1} \vert$$

(where f represents a focal distance of a lens, B represents the distance between two lenses, x1 represents an x coordinate on a three dimension of the left lens, and x2 represents an x coordinate on three dimension of the right lens).

The display unit may issue an alarm sound when the single distance and the stereo distance coinciding with each other by the weight control coincide with the single distance extracted from the third distance calculator.

According to another exemplary embodiment of the present invention, there is provided a glassless 3D image display method, including: calculating a first distance between a first stereo camera and a user; calculating a second distance between a second stereo camera and the first stereo camera and the user; registering information on a user's face when the first distance coincides with the second distance; calculating a third distance between a single camera and the user as the information on the registered user's face; and setting the third distance as a final distance in which the first distance coincides with the second distance.

The first distance and the third distance may be a single distance and the second distance may be a stereo distance.

When the first distance does not coincide with the second distance, it may be fedback to the calculating of the first distance between the first stereo camera and the user.

The first stereo camera and the second stereo camera may be disposed at the back surface of the handheld terminal and the single camera may be disposed at the front surface of the handheld terminal.

In the calculating of the first distance, the distance between the user and the first stereo camera may be calculated depending on the distance between the user's left eye and right eye and the distance between the user's right eye and nose, and the distance between the user's nose and left eye, respectively.

In the calculating of the third distance, the distance between the user and the single camera may be calculated depending on the distance between the user's left eye and right eye and the distance between the user's right eye and nose, and the distance between the user's nose and left eye, respectively.

The second distance may depend on the following Equation.

$$Z = \vert \frac{f \cdot B}{x 2 - x 1} \vert$$

(where f represents a focal distance of a lens, B represents the distance between two lenses, x1 represents an x coordinate on a three dimension of the left lens, and x2 represents an x coordinate on three dimension of the right lens)

In the registering of the information on the user's face, the distance between the user's left eye and right eye, the distance between the user's right eye and nose, and the distance between the user's nose and left eye according to the first distance and the second distance coinciding with each other and the first distance in response thereto may be registered.

The glassless 3D image display method may further include, after the setting of the third distance as a final distance, outputting an alarm sound.

The glassless 3D image display method may further include, after the outputting of the alarm sound, outputting a 3D image according to the final distance.

### BRIEF DESCRIPTION OF THE DRAWINGS

FIG. 1 is a block diagram of a glassless 3D image display apparatus according to an exemplary embodiment of the present invention.

FIG. 2 is an exemplified diagram of a distance measurement between a single camera and a user according to an exemplary embodiment of the present invention.

FIG. 3 is a diagram showing coordinates for describing a stereo distance measurement according to an exemplary embodiment of the present invention.

FIG. 4 is a flow chart of a glassless 3D image display method according to an exemplary embodiment of the present invention.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, the exemplary embodiments of the present invention will be described with reference to the accompanying drawings.

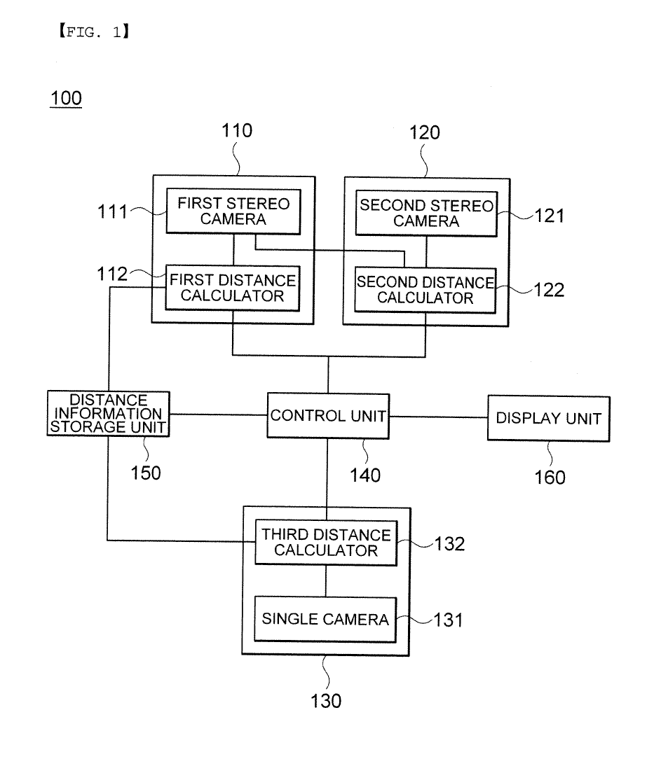

FIG. 1 is a block diagram of a glassless 3D image display apparatus according to an exemplary embodiment of the present invention.

Referring to 1, a glassless 3D image display apparatus 100 according to the exemplary embodiment of the present invention includes: a first imaging unit 110 extracting a single distance from a user; a second imaging unit 120 connected with the first imaging unit 110 to extract a stereo distance from the user; a control unit 140 coinciding the single distance with the stereo distance; a distance information storage unit 150 storing information on the single distance and the stereo distance coinciding with each other to register the user; a third imaging unit 130 extracting the single distance from the user based on the stored distance information; and a display unit 160 outputting the 3D image according to a distance extracted from the third imaging unit 130.

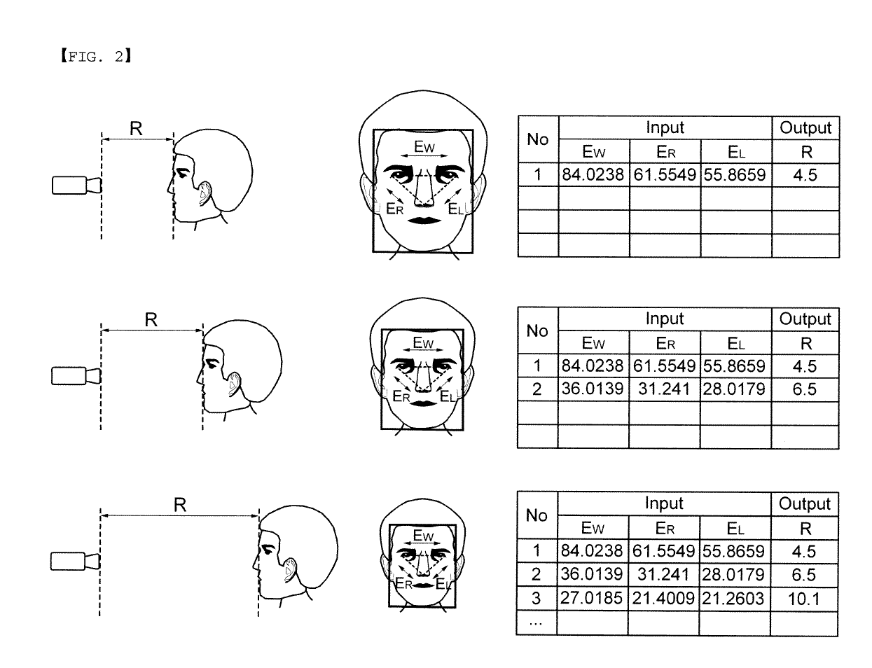

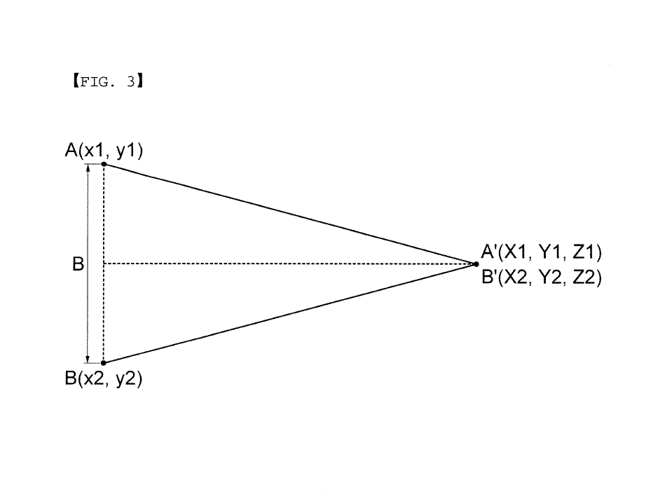

Here, the single distance means a distance measured between the camera and the user by using the single camera and the stereo distance means a distance measured between the camera and the user by using two cameras. Hereinafter, the contents will be described in detail with reference to FIGS. 2 and 3.

The first imaging unit 110 may include a first stereo camera 111 disposed on a back surface of the handheld terminal and a first distance calculator 112 connected with the first stereo camera 111 and calculating and extracting the single distance between the user and the first stereo camera 11, the second imaging unit 120 may include a second stereo camera 121 disposed at the left or the right on the same plane as the first stereo camera 111 and a second distance calculator 122 connected with the first stereo camera 111 and the second stereo camera 121 and calculating and extracting the stereo distance by the user and the first stereo camera 111 and the second stereo camera 121, and the third imaging unit 130 may include a single camera 131 disposed at the front surface of the handheld terminal and a third distance calculator 132 connected with the single camera 131 and calculating and extracting the single distance between the user and the single camera 131 according to the information stored in the distance information storage unit 150.

FIG. 2 is an exemplified diagram of a distance measurement between a single camera and a user according to an exemplary embodiment of the present invention.

Referring to FIG. 2, the first distance calculator 112 and the third distance calculator 132 may calculate and extract the distance as follows. The first distance calculator 112 may calculate and extract the single distance between the user and the first stereo camera 111 according to a distance between the user's left eye and right eye, a distance between user's right eye and nose, and a distance between user's nose and left eye, respectively.

Similarly, the third distance calculator 132 may calculate and extract the single distance between the user and the single camera 131 according to a distance between the user's left eye and user's right eye, a distance between the user's right eye and nose, and the user's nose and left eye, respectively.

The first distance calculated and measured by the first stereo camera 111 alone may adopt the same measuring and calculating scheme as the third distance calculated and measured by the single camera 131 alone. The second distance calculator 122 calculates and measures the distance by being simultaneously connected with the first stereo camera 111 and the second stereo camera 121 but the first distance calculator 112 calculates and measures the distance based on the first stereo camera 111 and therefore, the distance measuring scheme is not changed according to names of components. That is, when the distance is calculated and measured by the single camera regardless of the name of the single camera or the stereo camera, the single distance rather than the stereo distance is calculated and extracted.

The user's face may be photographed by the first stereo camera 111. In this case, it is possible to extract the user's left eye, right eye, and nose. It is possible to measure the mutual distance for the extracted user's left eye, right eye, and nose. That is, the distance between the user's left eye and right eye, the distance between the user's right eye and nose, and the distance between the user's nose and left eye may be input to the first distance calculator 112. Therefore, the first distance calculator 112 receives the values for the distance to output the distance between the first stereo camera 111 and the user by a neural network theory and a fuzzy theory. Therefore, as shown in FIG. 2, as each of the values input to the first distance calculator 112 is small, the output, that is, the distance between the user and the first stereo camera 111 is distant. The process of deriving a distance due to the neural network theory and the fuzzy theory is known and the detailed description thereof will be omitted. In addition, the distance measuring scheme by the first stereo camera 111 is the same as the distance measuring scheme by the single camera 131 and therefore, the distance measuring scheme by the single camera 131 and the third distance calculator 132 will be omitted.

In this case, the distance information storage unit 150 may store the distance between the user's left eye and right eye, the distance between the user's right eye and nose, and the distance between the user's nose and left eye, respectively, that are calculated by the first distance calculator 112.

In addition, the distance information storage unit 150 may store the distance between the user's left eye and right eye, the distance between the user's right eye and nose, the distance between the user's nose and left eye according to the single distance and the stereo distance coinciding with each other, and the single distance in response thereto, respectively.

FIG. 3 is a diagram showing coordinates for describing a stereo distance measurement according to an exemplary embodiment of the present invention.

Referring to FIG. 3, the second distance calculator 122 may extract the distance by the following calculation.

Coordinate A is a coordinate of one of two stereo cameras and coordinate B is a coordinate of the other stereo camera. Coordinate A may be a coordinate of the first stereo camera 111 and coordinate B may be a coordinate of the second stereo camera 121. That is, coordinate A may be a coordinate on an image plane in which a subject is taken by the first stereo camera 111 and coordinate B may be a coordinate on an image plane in which a subject is taken by the second stereo camera 121. In addition, coordinate A′ is a coordinate of a subject measured based on coordinate A and coordinate B′ is a coordinate of a subject measured based on coordinate B. Therefore, coordinate A and coordinate B are coordinates on the image plane and therefore, may be a two-dimensional coordinate and coordinate A′ and B′ are a coordinate in a space of a subject and therefore, may be a three-dimensional coordinate. In this case, the subject may be a user's face. In this case, an original point on the coordinate may be coordinate A and coordinate B.

Coordinates A and B are disposed on the same y axis and therefore, an equation of y1=y2 is established. Since coordinates A′ and B′ are coordinates of the subject measured based on each of the coordinates A and B having the same y coordinate of a single subject, equations of Y1=Y2 and Z1=Z2 are established. Therefore, when a focal distance of lenses of the first stereo camera 111 and the second stereo camera 121 are set to be f, the following Equations 1 and 2 are established.

$$\begin{matrix}\frac{X 1}{Z 1} = \frac{x 1}{f} & [ Equation 1 ] \\ \frac{X 2}{Z 2} = \frac{x 2}{f} ( Z 1 = Z 2 ) & [ Equation 2 ]\end{matrix}$$

When combining Equations 1 and 2, the following Equation 3 is established.

$$Z 1 = Z 2 = \frac{f \cdot ( X 2 - X 1 )}{x 2 - x 1} \qquad [ Equation 3 ]$$

Referring to FIG. 3, distance B corresponds to a distance between coordinate A and coordinate B and therefore, an equation of B=x2−x1 and B=X2−X1 is established as in Equation 4.

X2−X1=B [Equation 4]

Therefore, when combining Equations 3 and 4, the following Equation 5 is established.

Stereo Distance (Z1 or Z2)=|f·B/x2−x1| [Equation 5]

In this case, Z1 and Z2 have the same value and correspond to the stereo distance between the first stereo camera 111 and the second stereo camera 121 and the subject.

Therefore, the stereo distance depends on the following Equation.

$$Z = \vert \frac{f \cdot B}{x 2 - x 1} \vert$$

It may be defined by (where f represents a focal distance of a lens, B represents the distance between two lenses, x1 represents an x coordinate on a three dimension of the left lens, and x2 represents an x coordinate on three dimension of the right lens).

Here, in order to register the user, a single distance R described in FIG. 2 and a stereo distance Z described in FIG. 3 coincide with each other. Therefore, when the single distance extracted from the first distance calculator 112 does not coincide with the stereo distance extracted from the second distance calculator 122, the control unit 140 can control a weight by the neural network learning for the first distance calculator 112 to feedback the controlled weight until the single distance extracted from the first distance calculator 112 coincides with the stereo distance extracted from the second distance calculator 122. That is, when the single distance extracted from the first distance calculator 112 coincides with the stereo distance extracted from the second distance calculator 122, the feedback ends and the user may be registered. Here, the registration of the user may have a meaning that the information on the distance between the first stereo camera 111 and the user according to the information on the distance between the current user's left eye and right eye, the distance between the user's right eye and nose, and the distance between the user's nose and left eye is registered.

When the user is registered, the user may again extract the optimal distance according to the single distance measurement by making the user's face toward the single camera 131 of the handheld terminal. That is, after the user is registered by the first stereo camera 111 and the second stereo camera 121 that are disposed at the back surface of the handheld terminal, the 3D image may be displayed by extracting the optimal distance between the single camera 131 and the user using the single camera 131 that is disposed at the front surface of the handheld terminal. Therefore, when the single distance measured by the third distance calculator 132 coincides with the distance information stored in the distance information storage unit 150, the user can view the 3D image in an optimal state.

The display unit 160 may issue an alarm sound when the single distance and the stereo distance coinciding with each other by the weight control coincides with the single distance extracted from the third distance calculator 132.

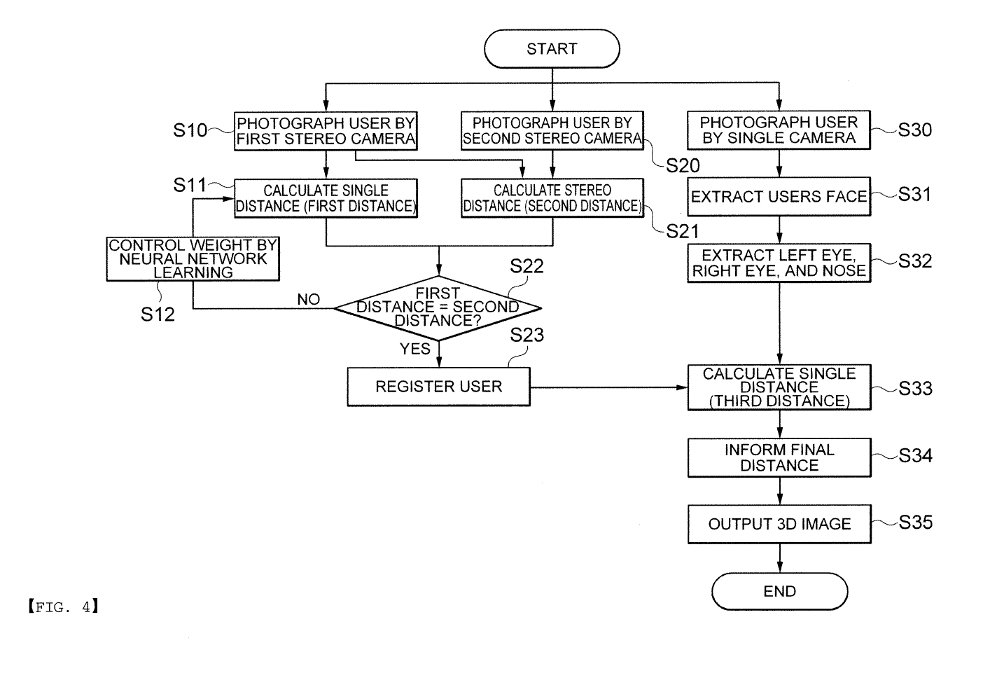

FIG. 4 is a flow chart of a glassless 3D image display method according to an exemplary embodiment of the present invention. The portions overlapping with the detailed description of the glassless 3D image display apparatus according to the exemplary embodiment of the present invention will be omitted.

Referring to FIG. 4, the glassless 3D image display method according to the exemplary embodiment of the present invention may include: calculating a first distance between the first stereo camera and the user (S11); calculating a second distance between the second stereo camera and the first stereo camera and the user (S21); registering the information on the user's face when the first distance coincides with the second distance (S23); calculating a third distance between the single camera and the user as the information on the registered user's face; and setting the third distance as a final distance in which the first distance coincides with the second distance.

The first distance and the third distance may be a single distance and the second distance may be a stereo distance. The meaning of the single distance and the stereo distance are already described and therefore, the description thereof will be omitted.

Prior to the calculating of the first distance (S11), the glassless 3D image display method may further include photographing the user by the first stereo camera (S10). In addition, prior to the calculating of the second distance (S20), the glassless 3D image display method may further include photographing the user by the first stereo camera and the second stereo camera (S10 and S20).

After the calculating of the first distance (S11) and the calculating of the second distance (S21), the glassless 3D image display method may further include determining whether the first distance is equal to the second distance (S22). When the first distance does not coincide with the second distance, the glassless 3D image display method may further include controlling a weight according to the neural network learning by being fedback to the calculating of the first distance between the first stereo camera and the user. That is, the calculating of the first distance may be fedback until the first distance coincides with the second distance by the weight control according to the neural network learning. When the first distance coincides with the second distance, the weight control may end by the feedback. A weight control method by the neural network learning is a known technology and the description of the first distance and the second distance is already described with reference to FIGS. 2 and 3 and therefore, the description thereof will be omitted.

The first stereo camera and the second stereo camera may be disposed at the back surface of the handheld terminal and the single camera may be disposed at the front surface of the handheld terminal.

In the calculating of the first distance, the distance between the user and the first stereo camera may be calculated depending on the distance between the user's left eye and right eye and the distance between the user's right eye and nose, and the distance between the user's nose and left eye, respectively. Similarly, in the calculating of the third distance, the distance between the user and the single camera may be calculated depending on the distance between the user's left eye and right eye and the distance between the user's right eye and nose, and the distance between the user's nose and left eye.

The second distance depends on the following Equation.

$$Z = \vert \frac{f \cdot B}{x 2 - x 1} \vert$$

It may be defined by (where f represents a focal distance of a lens, B represents the distance between two lenses, x1 represents an x coordinate on a three dimension of the left lens, and x2 represents an x coordinate on three dimension of the right lens).

In the registering of the information on the user's face, the distance between the user's left eye and right eye, the distance between the user's right eye and nose, and the distance between the user's nose and left eye according to the first distance and the second distance coinciding with each other and the first distance in response thereto may be registered.

After the registering of the information on the user's face, the method may further include photographing the user by the single camera (S30) and extracting the user's face (S31). In this case, after the extracting of the user's face (S31), the method may further include extracting the user's left eye, right eye, and nose (S32). As described above, when the user is registered, the user may again extract the optimal distance according to the single distance measurement by making the user's face toward the single camera of the handheld terminal. That is, after the user is registered by the first stereo camera and the second stereo camera that are disposed at the back surface of the handheld terminal, the 3D image may be displayed by extracting the optimal distance between the single camera and the user using the single camera that is disposed at the front surface of the handheld terminal. Therefore, the third distance coincides with the distance information on the registered user, the user can view the 3D image in the optimal state.

In this case, after the setting as the final distance, the method may further include outputting the alarm sound (S34).

In addition, after the outputting of the alarm sound, the method may further include outputting the 3D image according to the final distance (S35).

According to the exemplary embodiments of the present invention, it is possible to provide the optimal 3D image display environment to the user by accurately measuring the position of the user's eye and the distance between the user's eye and the display.

In addition, according to the exemplary embodiments of the present invention, it is possible to prevent the manufacturing cost of products from increasing by accurately measuring the point of view and the distance by the single camera of the front portion of the existing handheld terminal and the stereo camera of the back portion thereof, without adding the separate sensor or stereo camera.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

1. A glassless 3D image display apparatus, comprising:
a first imaging unit extracting a single distance from a user;
a second imaging unit connected with the first imaging unit to extract a stereo distance from the user;
a control unit coinciding the single distance with the stereo distance;
a distance information storage unit storing information on the single distance and the stereo distance coinciding with each other to register the user;
a third imaging unit extracting the single distance from the user based on the stored distance information; and
a display unit outputting a 3D image according to a distance extracted from the third imaging unit.

2. The glassless 3D image display apparatus according to claim 1, wherein the first imaging unit includes a first stereo camera disposed on a back surface of the handheld terminal and a first distance calculator connected with the first stereo camera and calculating and extracting the single distance between the user and the first stereo camera,
the second imaging unit includes a second stereo camera disposed at the left or the right on the same plane as the first stereo camera and a second distance calculator connected with the first stereo camera and the second stereo camera and calculating and extracting the stereo distance by the user and the first stereo camera and the second stereo camera, and
the third imaging unit includes a single camera disposed at the front surface of the handheld terminal and a third distance calculator connected with the single camera and calculating and extracting the single distance between the user and the single camera according to the information stored in the distance information storage unit.

3. The glassless 3D image display apparatus according to claim 2, wherein when the single distance extracted from the first distance calculator does not coincide with the stereo distance extracted from the second distance calculator, the control unit controls a weight by neural network learning for the first distance calculator to perform feedback until the single distance extracted from the first distance calculator coincides with the stereo distance extracted from the second distance calculator.

4. The glassless 3D image display apparatus according to claim 2, wherein the first distance calculator calculates and extracts a single distance between the user and the first stereo camera according to a distance between user's left eye and right eye, a distance between user's right eye and nose, and a distance between user's nose and left eye, respectively.

5. The glassless 3D image display apparatus according to claim 2, wherein the third distance calculator calculates and extracts a single distance between the user and the first stereo camera according to a distance between user's left eye and right eye, a distance between user's right eye and nose, and a distance between user's nose and left eye, respectively.

6. The glassless 3D image display apparatus according to claim 4, wherein the distance information storage unit stores a distance between user's left eye and right eye, a distance between user's right eye and nose, and a distance between nose and left eye, respectively, that are calculated by the first distance calculator.

7. The glassless 3D image display apparatus according to claim 5, wherein the distance information storage unit stores the distance between the user's left eye and right eye, the distance between the user's right eye and nose, the distance between the user's nose and left eye according to the single distance and the stereo distance coinciding with each other, and the single distance in response thereto, respectively.

8. The glassless 3D image display apparatus according to claim 2, wherein the stereo distance depends on the following Equation.
$$Z = \vert \frac{f \cdot B}{x 2 - x 1} \vert$$
(where f represents a focal distance of a lens, B represents the distance between two lenses, x1 represents an x coordinate on a three dimension of the left lens, and x2 represents an x coordinate on three dimension of the right lens).

9. The glassless 3D image display apparatus according to claim 2, wherein the display unit issues an alarm sound when the single distance and the stereo distance coinciding with each other by the weight control coincide with the single distance extracted from the third distance calculator.

10. A glassless 3D image display method, comprising:
calculating a first distance between a first stereo camera and a user;
calculating a second distance between a second stereo camera and the first stereo camera and the user;
registering information on a user's face when the first distance coincides with the second distance;
calculating a third distance between a single camera and the user as the information on the registered user's face; and
setting the third distance as a final distance in which the first distance coincides with the second distance.

11. The glassless 3D image display method according to claim 10, wherein the first distance and the third distance are a single distance and the second distance is a stereo distance.

12. The glassless 3D image display method according to claim 11, wherein when the first distance does not coincide with the second distance, it is fedback to the calculating of the first distance between the first stereo camera and the user.

13. The glassless 3D image display method according to claim 11, wherein the first stereo camera and the second stereo camera are disposed at a back surface of a handheld terminal and the single camera is disposed at a front surface of the handheld terminal.

14. The glassless 3D image display method according to claim 11, wherein in the calculating of the first distance, the distance between the user and the first stereo camera is calculated depending on a distance between a user's left eye and right eye, a distance between a user's right eye and nose, and a distance between a user's nose and left eye, respectively.

15. The glassless 3D image display method according to claim 11, wherein in the calculating of the third distance, the distance between the user and the single camera is calculated depending on a distance between a user's left eye and right eye, a distance between the user's right eye and nose, and a distance between the user's nose and left eye, respectively.

16. The glassless 3D image display method according to claim 11, wherein the second distance depends on the following Equation.
$$Z = \vert \frac{f \cdot B}{x 2 - x 1} \vert$$
(where f represents a focal distance of a lens, B represents the distance between two lenses, x1 represents an x coordinate on a three dimension of the left lens, and x2 represents an x coordinate on three dimension of the right lens)

17. The glassless 3D image display method according to claim 14, wherein in the registering of the information on the user's face, the distance between the user's left eye and right eye, the distance between the user's right eye and nose, and the distance between the user's nose and left eye according to the first distance and the second distance coinciding with each other and the first distance in response thereto are registered.

18. The glassless 3D image display method according to claim 10, further comprising: after the setting of the third distance as a final distance, outputting an alarm sound.

19. The glassless 3D image display method according to claim 18, further comprising: after the outputting of the alarm sound, outputting a 3D image according to the final distance.

20. The glassless 3D image display method according to claim 15, wherein in the registering of the information on the user's face, the distance between the user's left eye and right eye, the distance between the user's right eye and nose, and the distance between the user's nose and left eye according to the first distance and the second distance coinciding with each other and the first distance in response thereto are registered.

21. The glassless 3D image display method according to claim 16, wherein in the registering of the information on the user's face, the distance between the user's left eye and right eye, the distance between the user's right eye and nose, and the distance between the user's nose and left eye according to the first distance and the second distance coinciding with each other and the first distance in response thereto are registered.
